(19) United States
(12) Patent Application Publication
(10) Pub. No.: US 2023/0090179 A1
(43) Pub. Date: Mar. 23, 2023

(54) CLAMPING PLIERS HEAD AND CLAMPING PLIERS

(71) Applicant: ZHUJI ITOP HARDWARE TOOLS CO., LTD., Zhuji (CN)

(72) Inventor: Yuejuan SHEN, Zhuj (CN)

(73) Assignee: ZHUJI ITOP HARDWARE TOOLS CO., LTD., Zhuji (CN)

(21) Appl. No.: 17/453,423

(22) Filed: Nov. 3, 2021

(30) Foreign Application Priority Data
Sep. 23, 2021 (CN) 202122324994.0

(51) Int. Cl. B25B 27/10; B25G 1/04; B21D 39/04

(52) U.S. Cl. CPC B25B 27/10; B25G 1/04; B21D 39/046

(57) ABSTRACT

A clamping plier head is provided, which is used in cooperation with a first fitting and a second fitting. The second fitting is matched with the first fitting, and the clamping plier head includes an upper head, a lower head and an elastic clamping piece. The upper head and the plier head are matched to form an accommodating cavity for accommodating the first fitting and the second fitting, and at least one of the first fitting and the second fitting is detachably clamped on an inner wall of the accommodating cavity. The elastic clamping piece, with its own resilience, fixes the fittings detachably clamped on the inner wall to the inner wall.

### CROSS-REFERENCE TO RELATED APPLICATIONS

This Non-provisional application claims priority under 35 U.S.C. § 119(a) to Chinese Patent Application No. 202122324994.0, filed on 23 Sep. 2021, the entire contents of which are hereby incorporated by reference in its entirety.

### TECHNICAL FIELD

The disclosure relates to a technical field of hardware tools, in particular to a clamping plier head and a clipping plier.

### BACKGROUND ART

Clamping pliers, also known as crimping pliers, can be classified into wire crimping pliers, pipe crimping pliers and the like depending on their different functions. When the crimping pliers are configured to crimp pipe fittings, the opened crimping pliers clamp around the pipe fittings, the crimping pliers are completely aligned with the pipe fittings, and the arms acts to make a crimping head squeeze the pipe fittings, thus achieving a function of crimping the pipe fittings.

However, the existing crimping pliers have some disadvantages, such as a single function and no adapting to various types and shapes of acted objects such as pipe fittings or wires, etc. Even if a wide adaptability to pipe fittings of different sizes and shapes can be partly realized by replacing the fittings, the fittings of these tools are directly clamped on the crimping plier head through clamping grooves; in this way, the clamping is loose for convenience of replacement, which affects a final clamping effect, or the clamping is too tight, which is unfavorable for replacing. Secondly, during use, part of the acted object collides with the plier head, which affects using.

### SUMMARY

In order to overcome at least one disadvantages of the prior art, the disclosure provides a clamping plier head and a clipping plier which are unfavorable for disassembling and using.

In order to achieve above purposes, the disclosure provides a clamping plier head, which is used in cooperation with a first fitting and a second fitting. The second fitting is matched with the first fitting, and the clamping plier head includes an upper head, a lower head and an elastic clamping piece. The upper head and the lower head are matched to form an accommodating cavity for accommodating the first fitting and the second fitting, and at least one of the first fitting and the second fitting is detachably clamped on an inner wall of the accommodating cavity. The elastic clamping piece, with its own resilience, fixes the fitting detachably clamped on the inner wall to the inner wall.

After the first fitting and the second fitting are matched, a pressing area which can act on the acted object such as pipe fittings, connectors, wires or the like is created, so as to achieve purposes of clamping and shearing the acted object. A shape of the pressing area can be defined according to a shape of the acted object. In some possible embodiments, the first fitting and the second fitting can also be provided with a positioning structure for clamping the acted object, and the fittings (including the first fitting and the second fitting) in this application can be made of plastic, metal, cermet or composites of different materials. Although only the first fitting and the second fitting are described in this application, a third fitting, a fourth fitting or the like can also be used in technical schemes of this application, and a plurality of fittings can be matched with each other to form the pressing area.

In this application, at least one of the first fitting and the second fitting is detachably clamped on the inner wall of the accommodating cavity, that is to say, versatility of functions can be realized by configuring the fittings with different shapes, so that a wide adaptability to the acted object with different sizes and shapes can be provided; secondly, in this application, the fittings are fixed using the elastic clamping piece with their own resilience; when disassembled, the fittings can be easily disassembled by pulling the elastic clamping piece; when installed, the fitting detachably clamped on the inner wall can be fixed to the inner wall with the own resilience of the elastic clamping piece.

A head position relationship between the upper and lower heads can be an up-and-down relationship, or can be set in a left-and-right configuration. In other embodiments, it can also be an oblique orientation relationship or the like.

In this application, at most one of the first fitting and the second fitting can be fixedly connected with or integrally arranged with the upper head or the lower head.

Optionally, the elastic clamping piece is arranged along an axial direction of the plier head penetrating through the upper head or the lower head, and the fittings detachably clamped on the inner wall have a clamping part, and the elastic clamping piece includes a pressing end and a rebound end, and the rebound end automatically rebounds under an elastic action formed by displacement of the pressing end and fixedly adheres the clamping part to a side wall of the upper head or the lower head.

Optionally, the fittings detachably clamped on the inner wall have two clamping parts, and the two clamping parts form a U-shaped groove so as to be clamped on the inner wall of the accommodating cavity. In another possible embodiment, the fittings detachably clamped on the inner wall have a clamping part, and the two clamping parts form a L-shaped groove so as to be clamped on the inner wall of the accommodating cavity. Compared with the L-shaped groove, the U-shaped groove is more firm.

Optionally, the elastic clamping piece further comprises a connecting shaft, both ends of which are respectively arranged at the pressing end and the rebound end. The upper or lower head is provided with a through hole for accommodating the connecting shaft, and an elastic piece is also provided in the through hole, with one end of the elastic piece abutting against an inner wall of the through hole, and the other end of the elastic piece being fixed to the rebound end. A length of the connecting shaft is longer than that of the through hole. Any of the clamping parts is provided with a clamping hole to accommodate the connecting shaft. Threads can be provided on the connecting shaft. In a possible embodiment, the connecting shaft, pressing end and rebound end can be an integral bolt, and the rebound end is symmetrical about a central axis of the connecting shaft. A longest axis of the rebound end passing through a symmetry center on an end face proximate to the connecting shaft is larger than a size of an opening of the clamping hole, and the size of the opening of the clamping hole is larger than a diameter of the connecting shaft.

Optionally, the rebound end has a major axis (a longest axis on the end face) and a minor axis (a shortest axis on the end face), with a length of the major axis having to be no less than the size of the opening of the clamping hole and a length of the minor axis being larger than or less than the size of the opening of the clamping hole.

In a possible embodiment, the rebound end includes a regular polygonal prism which is arranged proximate to the connecting shaft, an end face of the regular polygonal prism proximate to the connecting shaft is shaped as a regular polygon, the longest axis passing through the symmetry center (i.e. the major axis) is a diameter of a circumscribed circle of the regular polygon, and the size of the opening of the clamping hole (i.e. the minor axis) is smaller than the diameter of the circumscribed circle of the regular polygon and larger than a diameter of an inscribed circle of the regular polygon.

When the elastic clamping piece fixes the clamping part, due to the length of the connecting shaft being longer than the length of the through hole, the pressing end must not be attached to a side wall of the upper head or the lower head at this time. When the fitting is not installed, that is, in a general state, the elastic clamping piece is also consistent with an upper clamping state. When the two actions, disassembling and installing, are required, the pressing end is pressed or acted on with other actions so that the pressing end gradually gets close to the side wall while the rebound end get gradually away from the side wall, and the elastic piece is gradually in urgent need of resilience. At this time, the fitting can be disassembled or installed, and when the pressing end is released, it automatically rebounds and fixedly attaches the clamping part.

Optionally, a shape of the clamping hole is set according to a shape of the connecting shaft, and an aperture at the opening of the clamping hole is not larger than that proximate to the opening. An expression “proximate to the opening” refers to a position more close to the opening in a direction along which a hole depth of the clamping hole extends from shallow to deep. Further optionally, a hole depth proximate to the opening can be 10%-70% of a whole depth of the clamping hole, and still further optionally, the hole depth proximate to the opening can be 30%-50% of the whole depth of the clamping hole. This structure which is small at the opening and large inside is favorable for the connecting shaft not easily coming out of the opening. Optionally, the aperture of the clamping hole gradually increases along a hole depth direction of the clamping hole firstly for convenience of installation, where a gradually increasing part is a part of the clamping hole proximate to the opening. In another embodiment, the aperture of the clamping hole does not need to gradually increase along the hole depth direction of the clamping hole, but only a few areas of the clamping hole are larger than the opening, with a better clamping effect.

Optionally, two opposite side walls of the lower head are respectively provided with oppositely disposed grooves, so as to facilitate mounting of the acted object.

Optionally, a groove bottom of at least one of the grooves is flush with the clamping part of the first fitting in such a way that a groove bottom of one of the grooves is flush with the engaging part of the first fitting while a groove bottom of another groove is slightly higher or lower than the clamping part of the first fitting, or groove bottoms of the two grooves are both flush with the engaging part of the first fitting. The “flush” here does not means completely flush, and also includes “substantially flush”.

Optionally, a first end of the upper head is hinged with a third end of the lower head. A second end of the upper head opposite to the first end is detachably clamped with a fourth end of the lower head opposite to the third end. The fourth end of the lower head is clamped with the second end of the upper head to form an accommodating cavity, and the fourth end and the second end are respectively provided with a clamping groove and a bump which are matchingly clamped with each other. With this structure, an opening or closing of the accommodating cavity can be realized, and this operation is simple. When the second end and the fourth end are opened, respective fittings can be installed at the upper head and the lower head respectively, and then the second end and the fourth end are clamped, and the first fitting and the second fitting cooperate to form the pressing area.

Optionally, the second end is cylindrical in shape, the clamping groove is radially arranged on a cylindrical side of the second end, an axial section of the upper head is semi-circular, a position of the bump corresponding to the clamping groove is arranged on the side of the lower head, and the bump can slide along the clamping groove. The cylindrical side of the second end refers to a face of the cylinder which is not any one of two opposite circular faces. When the second end and the fourth end are clamped with each other gradually, the bump can slide along the clamping groove on the cylinder, which not only can be positioned but also can be fixed.

Optionally, the clamping plier head further includes a buckle which is arranged on a side proximate to the second end, and when the fourth end and the second end are clamped, the buckle is configured for further buckling to fix the second end.

The application also provides a clamping plier, which includes any one of the clamping plier heads as shown above, a pushing mechanism and a left plier handle and a right plier handle which are matched with each other and are both telescopic. The pushing mechanism is configured to push one of the first fitting and the second fitting so that the pushed fitting approaches the other fitting; and the left and right plier handles is configured to push the pushing mechanism.

Optionally, any one of the left plier handle and the right plier handle includes an inner sleeve, at least one breaking snap ring and an outer sleeve. A tail end of the inner sleeve is connected with an eccentric plug, and the inner sleeve is provided with an annular groove; the at least one breaking snap ring is clamped on the annular groove to form an annular protrusion; the outer sleeve is sleeved outside the inner sleeve; and an end of the outer sleeve is provided with an annular step for clamping the annular protrusion. In order to prevent the inner pipe from falling out of the outer pipe, some people also use a pull rope, but the pull rope is easy to be broken and can be entangled with the pipe.

Optionally, a head end of the inner sleeve is fixed on the propulsion mechanism, and the tail end of the inner sleeve is fixed with the eccentric plug which includes an eccentric shaft and a broken rotating part, and the rotating part is rotatably sleeved outside the eccentric shaft, so that the inner sleeve and the outer sleeve are locked or unlocked through the eccentric plug when the outer sleeve and the inner sleeve rotate relatively.

Optionally, the eccentric plug also includes a connecting shaft, the tail end of the inner sleeve fixes the connecting shaft through a pin shaft, a side of the eccentric shaft is provided with a stop block, and the rotating part is provided with a stop step arranged oppositely to the stop block.

To sum up, in the plier head and the clamping plier including the plier head provided in this disclosure, at least one of the first fitting and the second fitting is detachably clamped on the inner wall of the accommodating cavity, that is to say, versatility of functions can be realized by configuring the fittings with different shapes, so that a wide adaptability to the acted object with different sizes and shapes can be provided; secondly, in this application, the fittings are fixed using the elastic clamping piece with their own resilience; when disassembled, the fittings can be easily disassembled by pulling the elastic clamping piece; when installed, the fitting detachably clamped on the inner wall can be fixed to the inner wall with the own resilience of the elastic clamping piece.

### BRIEF DESCRIPTION OF THE DRAWINGS

FIG. 1 is a schematic diagram of a clamping plier in an open state according to an embodiment of the disclosure;

FIG. 2 is a bottom view of a clamping plier in an open state according to an embodiment of the disclosure;

FIG. 3 is a sectional view taken along A-A in FIG. 2;

FIG. 4 is an enlarged view of the right plier handle in FIG. 3;

FIG. 5 is a front view of a clamping plier in an open state according to an embodiment of the disclosure;

FIG. 6 is a rear view of a clamping plier in an open state according to an embodiment of the disclosure;

FIG. 7 is a top view of a clamping plier in a closed state according to an embodiment of the disclosure;

FIG. 8 is a sectional view taken along line B-B in FIG. 7;

FIG. 9 is a schematic diagram of a clamping plier in a closed state according to an embodiment of the disclosure;

FIG. 10 is a schematic diagram of a clamping plier head in an open state according to an embodiment of the disclosure;

FIG. 11 is another schematic diagram of a clamping plier head in an open state according to an embodiment of the disclosure;

FIG. 12 is a schematic diagram of a clamping plier head, with fittings removed, in an open state according to an embodiment of the disclosure;

FIG. 13 is a schematic diagram of a first fitting and a second fitting according to an embodiment of the disclosure;

FIG. 14 is another schematic diagram of a first fitting and a second fitting according to an embodiment of the disclosure;

FIG. 15 is a schematic diagram of an outer sleeve according to an embodiment of the disclosure;

FIG. 16 is a schematic diagram of an inner sleeve, a snap ring and an eccentric plug according to an embodiment of the disclosure;

FIG. 17 is an exploded view of an inner sleeve, a snap ring and an eccentric plug according to an embodiment of the disclosure;

FIG. 18 is a schematic diagram of an eccentric plug according to an embodiment of the disclosure;

FIG. 19 is a schematic diagram of a rotating part according to an embodiment of the disclosure;

FIG. 20 is an exploded view of a propulsion mechanism according to an embodiment of the disclosure;

FIG. 21 is a schematic diagram of a ratchet mechanism according to an embodiment of the disclosure;

FIG. 22 is a schematic diagram of an eccentric shaft of the propulsion mechanism according to an embodiment of the disclosure;

FIG. 23 is a schematic view of an end face of the fitting near the pressing part according to an embodiment of the disclosure;

FIG. 24 is a side view of the elastic clamping piece according to an embodiment of the disclosure;

FIG. 25 is a front view of the elastic clamping piece according to an embodiment of the disclosure.

### DETAILED DESCRIPTION

In order to make the above and other objects, features and advantages of the utility model more obvious and understandable, a detailed description is made below for the preferred embodiments with reference to the accompanying drawings.

An axial direction of the plier head refers to a direction perpendicular to the section in FIG. 3.

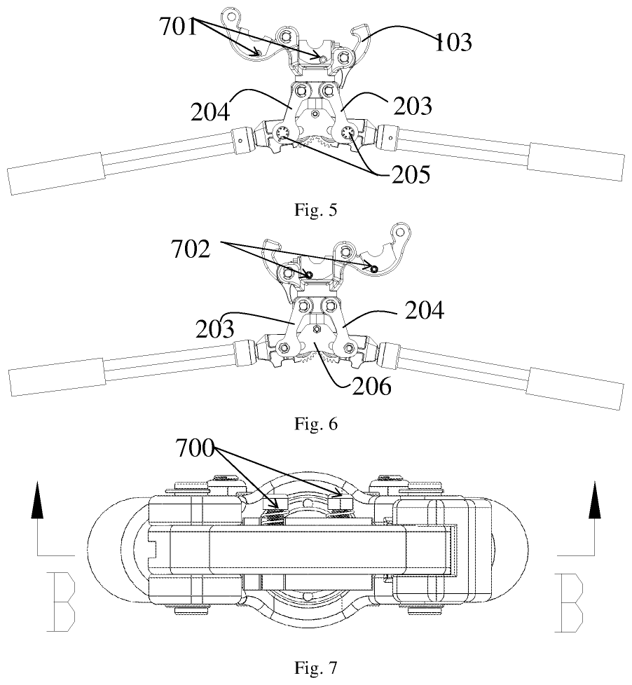

A side wall of the upper head or the lower head refers to an outer wall of the upper head or the lower head in a direction shown in FIG. 5 or FIG. 6.

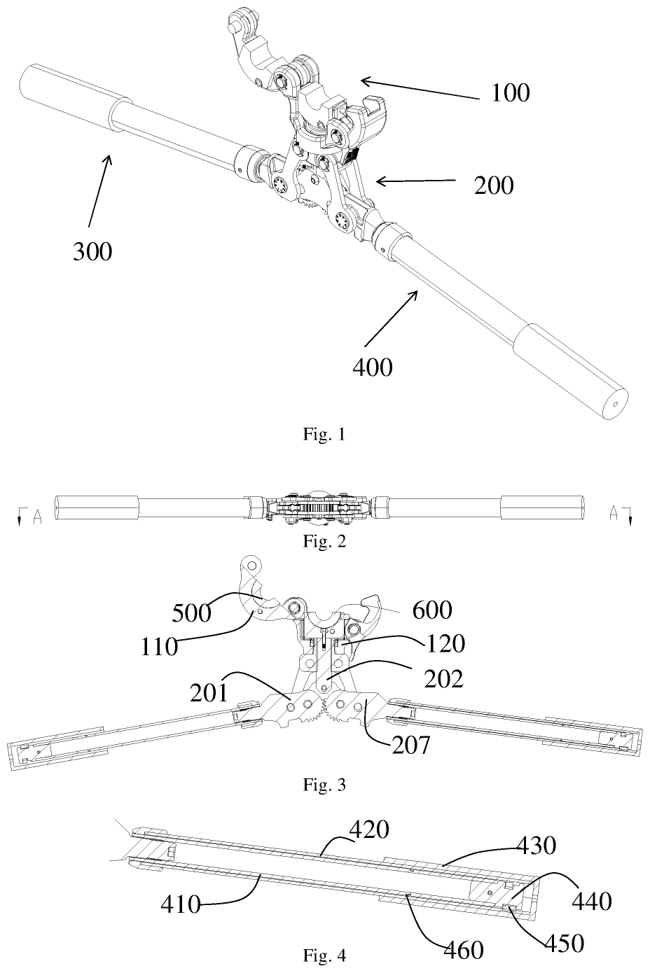

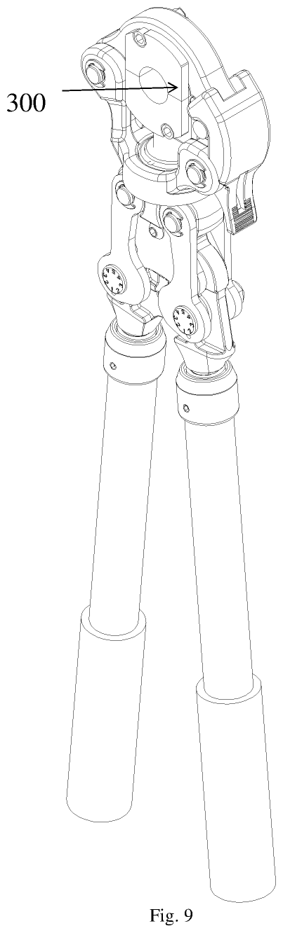

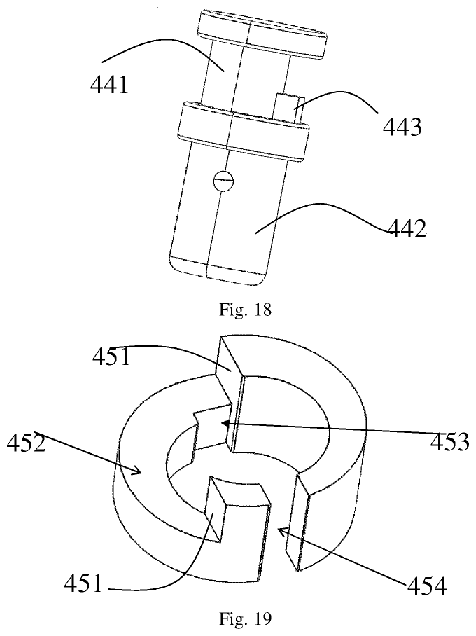

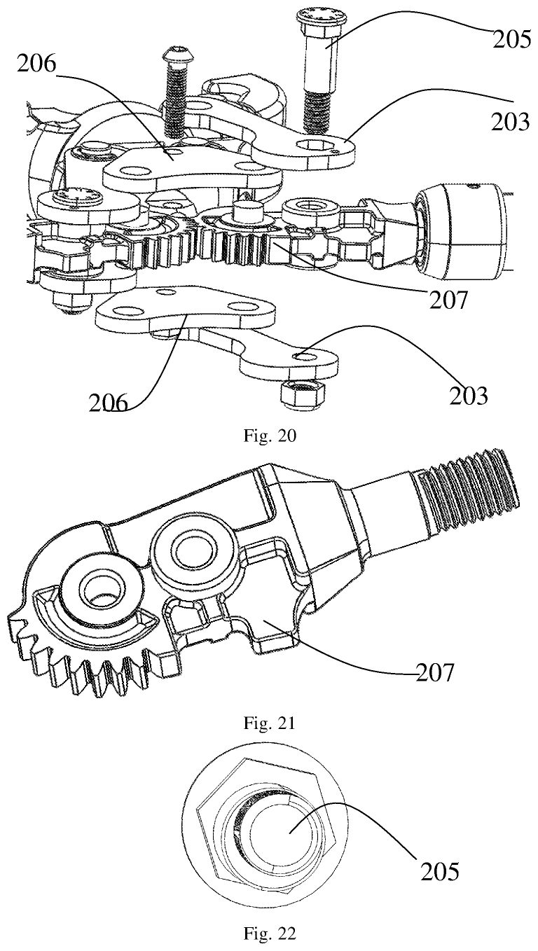

With reference to FIGS. 1 to 22, an embodiment provides a clamping plier, which includes a clamping plier head 100, a pushing mechanism 200, and a left plier handle 300 and a right plier handle 400 which are mutually matched and are both telescopic. The pushing mechanism 200 is configured to push one of the first fitting 500 and the second fitting 600 so that the pushed fitting approaches the other fitting; and the left 300 and right 400 plier handles are configured to push the pushing mechanism 200. The plier head 100 is used in cooperation with the first fitting 500 and the second fitting 600. The second fitting 600 is matched with the first fitting 500, and the clamping plier head 100 includes an upper head 110, a lower head 120 and an elastic clamping piece 700. The upper head 110 and the plier head 120 are matched to form an accommodating cavity for accommodating the first fitting 500 and the second fitting 600, and the first fitting 500 and the second fitting 600 are both detachably clamped on an inner wall of the accommodating cavity. The elastic clamping piece 700, with its own resilience, fixes the fittings detachably clamped on the inner wall to the inner wall.

In this application, the first fitting 500 and the second fitting 600 are both detachably clamped on the inner wall of the accommodating cavity, that is to say, versatility of functions can be realized by configuring the fittings with different shapes, so that a wide adaptability to the acted object with different sizes and shapes can be provided, and in this embodiment, the first fitting and the second fitting with different sizes and with semicircular shapes are provided; secondly, in this application, the fittings are fixed using the elastic clamping piece 700 with their own resilience; when disassembled, the fittings can be easily disassembled by pulling the elastic clamping piece 700; when installed, the fitting detachably clamped on the inner wall can be fixed to the inner wall with the own resilience of the elastic clamping piece 700.

In this embodiment, the elastic clamping piece 700 is arranged along an axial direction of the plier head 100 penetrating through the upper head 110 or the lower head 120, and the fittings detachably clamped on the inner wall have a clamping part 610, and the elastic clamping piece 700 includes a pressing end 702 and a rebound end 701, and the rebound end 701 automatically rebounds under an elastic action formed by displacement of the pressing end 702 and fixedly adheres the clamping part 610 to a side wall of the upper head 110 or the lower head 120.

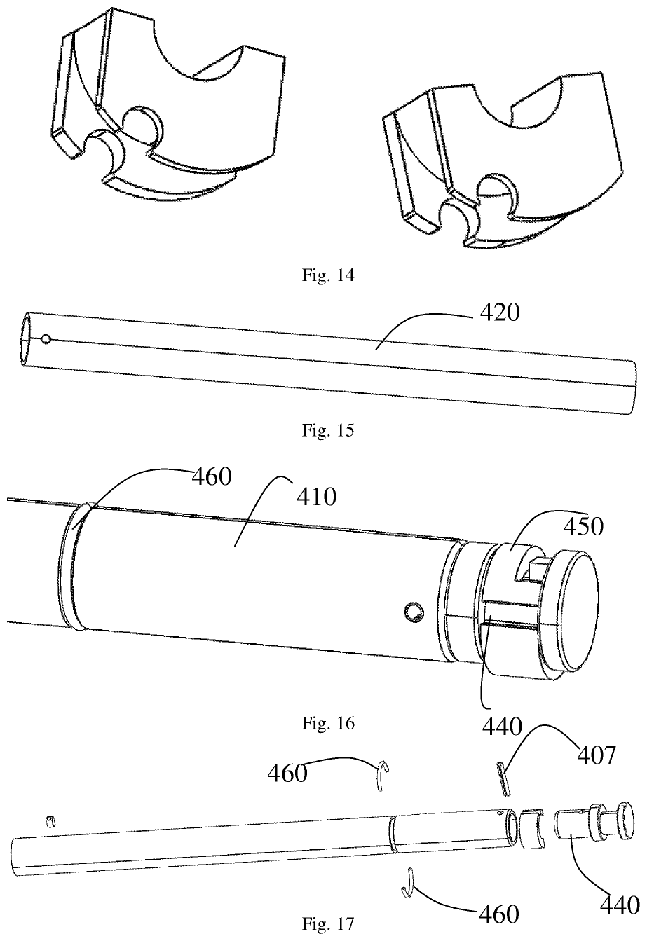

As shown in FIGS. 13 and 14, in this embodiment, the fittings detachably clamped on the inner wall have two clamping parts 610, and the two clamping parts 610 form a U-shaped groove 612 so as to be clamped on the inner wall of the accommodating cavity.

In this embodiment, the elastic clamping piece 700 further comprises a connecting shaft 703, both ends of which are respectively arranged at the pressing end 702 and the rebound end 701. The upper 110 or lower 120 head is provided with a through hole for accommodating the connecting shaft, and an elastic piece is also arranged in the through hole, with one end of the elastic piece abutting against an inner wall of the through hole, and the other end of the elastic piece being fixed to the rebound end 701 or the other end of the elastic piece being fixed to the pressing end 702. A length of the connecting shaft is longer than that of the through hole. Any of the clamping parts 610 is provided with a clamping hole 611 to accommodate the connecting shaft. When the elastic clamping piece 700 fixes the clamping part 610, due to the length of the connecting shaft being longer than the length of the through hole, the pressing end 702 must not be attached to a side wall 124 of the upper head 110 or the lower head 120 at this time. When the fitting is not installed, that is, in a general state, the elastic clamping piece 700 is also consistent with an upper clamping state. When the two actions, disassembling and installing, are required, the pressing end 702 is pressed or acted on with other actions so that the pressing end 702 gradually gets close to the side wall while the rebound end 701 get gradually away from the side wall, and the elastic piece is gradually in urgent need of resilience. At this time, the fitting can be disassembled or installed, and when the pressing end 702 is released, it automatically rebounds and fixedly attaches the clamping part 610.

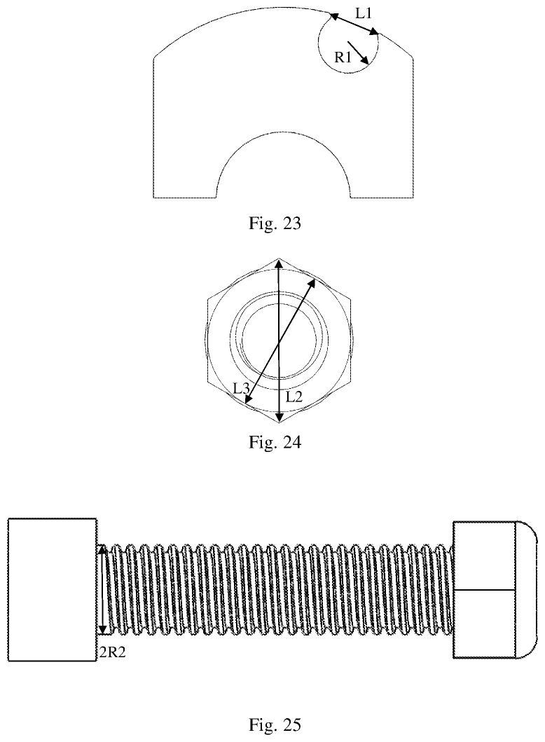

As shown in FIGS. 23-25, the rebound end includes a hexagonal nut, and an end face of the hexagonal nut proximate to the connecting shaft is of a regular hexagon in shape. A longest axis passing through a symmetry center is a diameter L2 of a circumscribed circle of the regular hexagon. A size L1 of an opening of the clamping hole is smaller than a diameter L3 of an inscribed circle of the regular hexagon, and the size L1 of the opening of the clamping hole is larger than a diameter of the connecting shaft, that is, 2R2, and the diameter L2 of the circumscribed circle of the regular hexagon is less than two times R1, that is 2 R2<L1<L3<L2<2R1, even when a shortest axis, that is, L3, is clamped at the opening of the clamping hole, a fixed role can be played, and other axes are longer than the shortest axis and can also function to fix.

In another embodiment, the size L1 of the opening of the clamping hole is smaller than the diameter L2 of the circumscribed circle of the regular hexagon and larger than the diameter L3 of the inscribed circle of the regular hexagon, and the diameter L3 of the inscribed circle of the regular hexagon is larger than the diameter of the connecting shaft, that is 2R2, and the diameter L2 of the inscribed circle of the regular hexagon is less than two times R1, that is, 2 R2<L3<L1<L2<2R1, and at this time, when the nut rotates to a certain angle, the longer shaft L2 is clamped at the opening, the fixed role can be played.

In this embodiment, a shape of the clamping hole 611 is set according to a shape of the connecting shaft, and the connecting shaft in this disclosure is a cylindrical connecting shaft, and thus the shape of the clamping hole 611 is a circle with a notch, and a corresponding radius angle of the notch is less than 90 degrees, and an aperture at the opening of the clamping hole 611 is not larger than that proximate to the opening. In this embodiment, a hole depth proximate to the opening can be 12% of a whole depth of the clamping hole 611, that is to say, a size of the clamping hole at a position about 12% of the whole depth away from the opening in a hole depth direction is not smaller than that at the opening, and in other embodiments, the hole depth proximate to the opening can be can also be 15%, 20%, 25%, 30%, 35%, 50%, 60%, 70% of the whole depth of the clamping hole. The applicant found through experiments that when this value is within a range of 10%-70%, it is favorable for fixing and installation. And in this embodiment, the aperture of the clamping hole 611 gradually increases along the hole depth direction of the clamping hole 611 firstly, which is favorable for installation. And a gradually increasing part is a part of the clamping hole 611 proximate to the opening.

In this embodiment, a first end 111 of the upper head 110 is hinged with a third end 113 of the lower head 120. A second end 112 of the upper head 110 opposite to the first end is detachably clamped with a fourth end 114 of the lower head 120 opposite to the third end. The fourth end of the lower head 120 is clamped with the second end of the upper head 110 to form an accommodating cavity, and the fourth end and the second end are respectively provided with a clamping groove and a bump which are matchingly clamped with each other. With this structure, an opening or closing of the accommodating cavity can be realized, and this operation is simple. When the second end and the fourth end are opened, respective fittings can be installed at the upper head 110 and the lower head 120 respectively, and then the second end and the fourth end are clamped, and the first fitting 500 and the second fitting 600 cooperate to form the pressing area 800.

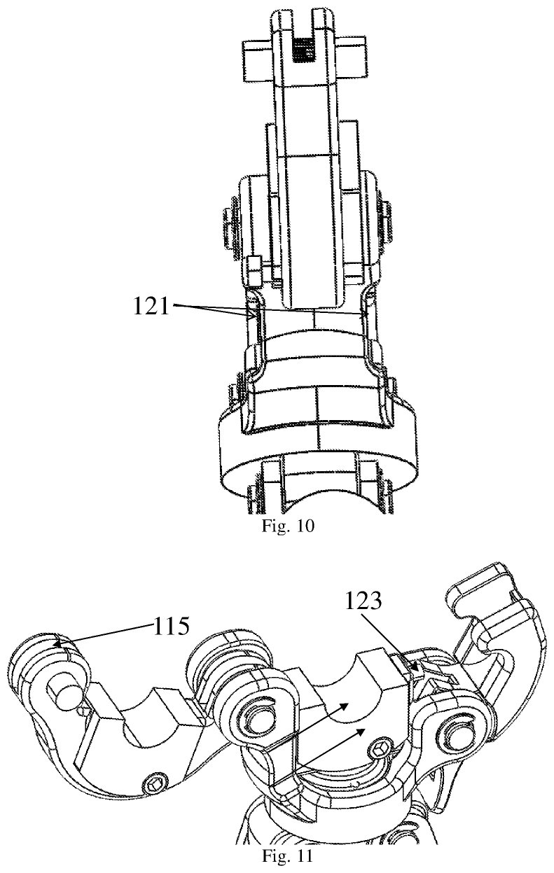

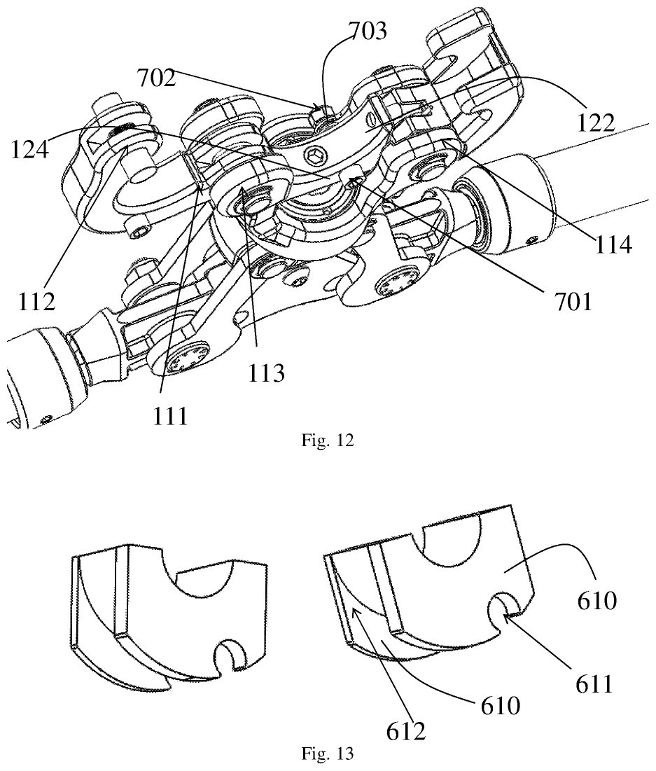

As shown in FIGS. 11 and 12, in this embodiment, the second end is cylindrical in shape, the clamping groove 115 is radially arranged on a cylindrical side of the second end, an axial section of the upper head 110 is semi-circular; and the lower head 120 includes a mounting base 122 for mounting the fittings, an axial section of the mounting base is rectangular in shape, and a bump 123 is arranged on a side of the mounting base at a position corresponding to the clamping groove. The side of the mounting base refers to a face perpendicular to a side wall of the lower head 120 and far away from the first end and the third end, and the side also faces a buckle described below, and the bump can slide along the groove. When the second end and the fourth end are clamped with each other gradually, the bump can slide along the clamping groove on the cylinder, which not only can be positioned but also can be fixed.

In this embodiment, the clamping plier head 100 further comprises a buckle 103, which is arranged on a side proximate to the second end and is hinged with the fourth end. When the fourth end and the second end are clamped, the buckle is configured for further buckling to fix the second end.

In this embodiment, two opposite side walls of the lower head 120 are respectively provided with oppositely disposed grooves 121 which are provided across surfaces of the side walls, so as to facilitate mounting of the acted object. As shown in FIG. 10, a shape of the groove in this embodiment is an arc-shaped, and a bottom of the groove also smoothly transits with an arc. The groove extends from an end of the lower head 120 proximate to the pushing mechanism 200 to the third end, and an extending direction of both side walls of the groove is directed to or roughly directed to the accommodating cavity, as shown by a black solid arrow in FIG. 11.

In this embodiment, a groove bottom of one of the grooves is flush with the clamping part 610 of the first fitting 500, and a groove bottom of another groove is slightly higher than the clamping part 610 of the first fitting 500, thus protecting the fitting from wearing.

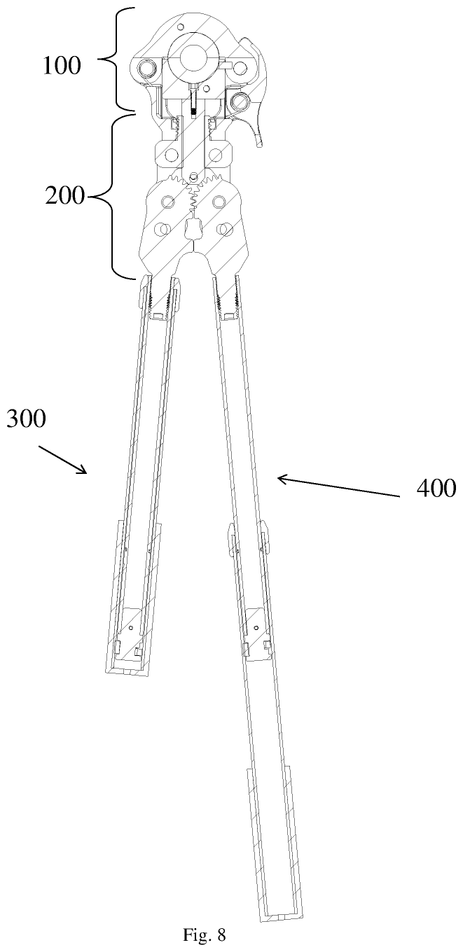

As shown in FIGS. 15 to 19, in this embodiment, any one of the left plier handle 300 and the right plier handle 400 includes an inner sleeve 410, two breaking snap rings 460 and an outer sleeve 420. A tail end of the inner sleeve 410 is connected with an eccentric plug 440, and the inner sleeve 410 is provided with an annular groove; the two breaking snap rings 460 are clamped on the annular groove to form an annular protrusion. In this embodiment, two breaking snap rings 460 are installed on the annular groove to substantially form a ring. In other embodiments, the ring may not be formed, that is to say, there will be a gap after the snap rings are installed. The outer sleeve 420 is sleeved outside the inner sleeve 410; and an end of the outer sleeve 420 is provided with an annular step for clamping the annular protrusion, and the breaking annular snap rings are favorable for installation. There is also a protective sleeve 430 outside the outer sleeve 420. When the outer sleeve 420 is pulled out, that is, the outer sleeve 420 and the inner sleeve 410 move relatively to each other. When the annular step on the outer sleeve 420 contacts the annular protrusion of the inner sleeve 410 and is clamped, and then this extended state is locked by the eccentric plug 440. Likewise, the opposite is true when the plier handles are contracted. FIG. 8 is a schematic diagram showing one plier handle being in the extended state and the other plier handle being in a contracted state.

In this embodiment, a head end of the inner sleeve 410 is fixed on the propulsion mechanism 200, and the tail end of the inner sleeve 410 is fixed with the eccentric plug 440 which includes an eccentric shaft 441 and a broken rotating part 450, and the rotating part 450 is rotatably sleeved outside the eccentric shaft, so that the inner sleeve 410 and the outer sleeve 420 are locked or unlocked through the eccentric plug 440 when the outer sleeve 420 and the inner sleeve 410 rotate relatively.

In this embodiment, the eccentric plug 440 also includes a connecting shaft 442, the tail end of the inner sleeve 410 fixes the connecting shaft through a pin shaft 407, a side of the eccentric shaft is provided with a stop block 443, a height of the stop block is lower than a shaft length of the eccentric shaft, the rotating part 450 is provided with a stop step 451 arranged oppositely to the stop block, and also provided with a groove 452 for the stop block to slide, and also axially provided with a groove 453 on a side of the breaking 454 opposite to the rotating part 450, and the groove 453 is disposed on the inner wall of the rotating part.

As shown in FIGS. 3, and 20 to 22, the pushing mechanism 200 in this embodiment sequentially comprises, from outside to inside, two left cover plates 204 and two right cover plates 203 which are connected with the left and right plier handles 400 respectively and are arranged vertically symmetrically, two triangular cover plates 206 which are arranged vertically symmetrically at a middle position and two ratchet mechanisms meshed with each other; further, it also includes an ejector 202, an end of which can act on the mounting base and thus act on the fittings. A left ratchet mechanism 201 is fixedly connected with the left plier handle 300, a right ratchet mechanism 207 is fixedly connected with the right plier handle 400, and the two left cover plates 204 and the left ratchet mechanism are connected through an eccentric shaft 205, two right cover plates 203 and the right ratchet mechanism are also connected through an eccentric shaft 205; and the two meshed ratchet mechanisms are connected to two ends of the two triangular cover plates 206 away from the plier head 100, and the third ends of the two triangular cover plates 206 are connected with the ejector. When the two ratchet mechanisms are driven by the left and right plier handles 400, thus driving the triangular cover plate 206 to displace, displacing of the ejector can be realized, and finally displacing of the fittings clamped on the mounting base can be realized, thus further realizing the clamping of the acted object. The eccentric shaft can be provided to adjust a position of the ejector, thereby adjusting a position of the mounting base and realizing a degree of clamping. An end of each of the two left cover plates 204 is connected to the left ratchet mechanism and the other end thereof is connected to the plier head; an end of each of two right cover plates 203 is connected to the right ratchet mechanism and the other end thereof is connected to the plier head. In other embodiments, the two left cover plates 204 and the two right cover plates 203 can be removed.

It should be understood by those skilled in the art that in the disclosure of the disclosure, the orientation or positional relationship indicated by the terms “upper”, “lower”, “front”, “rear”, “left”, “right”, “vertical”, “horizontal”, “top”, “bottom”, “inner” and “outer” or the like are based on the orientation or positional relationship shown in the drawings, which are only for convenience of describing the disclosure and for simplifying the description, but do not indicate or imply that the indicated device or element must have a specific orientation, be constructed and operate in a specific orientation; therefore the above-mentioned terms cannot be understood as limitations to the disclosure.

Although the disclosure has been disclosed by the preferred embodiment in the above, it is not intended to limit the disclosure and any person familiar with the art can make some changes and embellishments without departing from the spirit and scope of the disclosure; therefore, the scope of protection of the disclosure should be subject to the scope of protection as claimed in the claims.

What is claimed is:

1. A clamping plier head, being used in cooperation with a first fitting and a second fitting, wherein the second fitting is matched with the first fitting, and the clamping plier head comprises:
an upper head and a lower head, the upper head and the lower head being matched to form an accommodating cavity for accommodating the first fitting and the second fitting, and at least one of the first fitting and the second fitting being detachably clamped on an inner wall of the accommodating cavity; and
an elastic clamping piece, with its own resilience, fixing the fitting detachably clamped on the inner wall to the inner wall.

2. The clamping plier head according to claim 1, wherein the elastic clamping piece is arranged along an axial direction of the plier head penetrating through the upper head or the lower head, and the elastic clamping piece comprises a pressing end, a rebound end and a connecting shaft; two opposite ends of the connecting shaft are respectively arranged at the pressing end and the rebound end, the fitting detachably clamped on the inner wall is provided with a clamping hole for accommodating the connecting shaft, the upper or lower head is provided with a through hole for accommodating the connecting shaft, and an elastic piece is also provided in the through hole, with one end of the elastic piece abutting against an inner wall of the through hole, and the other end of the elastic piece being fixed to the rebound end or the pressing end; a length of the connecting shaft is longer than that of the through hole, the rebound end has a major axis with a length not less than a size of the opening of the clamping hole.

3. The clamping plier head according to claim 1, wherein two opposite side walls of the lower head are respectively provided with oppositely disposed grooves, and a groove bottom of at least one of the grooves is flush with the clamping part of the first fitting.

4. The clamping plier head according to claim 1, wherein a first end of the upper head is hinged with a third end of the lower head, a second end of the upper head opposite to the first end is detachably clamped with a fourth end of the lower head opposite to the third end; the fourth end of the lower head is clamped with the second end of the upper head to form the accommodating cavity, and the fourth end and the second end are respectively provided with a clamping groove and a bump which are matched with each other.

5. The clamping plier head according to claim 4, wherein the second end is cylindrical in shape, the clamping groove is radially arranged on a cylindrical side of the second end, an axial section of the upper head is semi-circular, the bump is arranged on the side of the lower head corresponding to a position of clamping groove, and the bump is slidable along the clamping groove.

6. The clamping plier head according to claim 5, wherein the clamping plier head further comprises a buckle which is arranged on a side proximate to the second end, and when the fourth end and the second end are clamped, the buckle is configured for buckling the second end.

7. A clipping plier, comprising:
the clamping plier head according to claim 1;
a pushing mechanism configured to push one of the first fitting and the second fitting so that the pushed fitting approaches the other fitting;
a left plier handle and a right plier handle which are matched with each other and are both telescopic, the left plier handle and the right plier handle being matched for pushing the pushing mechanism.

8. The clipping plier according to claim 7, wherein any one of the left plier handle and the right plier handle comprises:
an inner sleeve, a tail end of the inner sleeve being connected with an eccentric plug, and the inner sleeve being provided with an annular groove;
at least one breaking snap ring clamped on the annular grooves to form an annular protrusion;
an outer sleeve sleeved outside the inner sleeve, an end of the outer sleeve being provided with an annular step for clamping the annular protrusion.

9. The clipping plier according to claim 8, wherein a head end of the inner sleeve is fixed at the propulsion mechanism, and the tail end of the inner sleeve is fixed with the eccentric plug which includes an eccentric shaft and a broken rotating part, and the rotating part is rotatably sleeved outside the eccentric shaft, so that the inner sleeve and the outer sleeve are locked or unlocked through the eccentric plug when the outer sleeve and the inner sleeve rotate relatively.

10. The clipping plier according to claim 9, wherein the eccentric plug also includes a connecting shaft, the tail end of the inner sleeve fixes the connecting shaft through a pin shaft, a side of the eccentric shaft is provided with a stop block, and the rotating part is provided with a stop step arranged oppositely to the stop block.

11. The clamping plier head according to claim 2, wherein a first end of the upper head is hinged with a third end of the lower head, a second end of the upper head opposite to the first end is detachably clamped with a fourth end of the lower head opposite to the third end; the fourth end of the lower head is clamped with the second end of the upper head to form an accommodating cavity, and the fourth end and the second end are respectively provided with the clamping groove and a bump which are matched with each other.

12. The clamping plier head according to claim 11, wherein the second end is cylindrical in shape, the clamping groove is radially arranged on a cylindrical side of the second end, an axial section of the upper head is semi-circular, the bump is arranged on the side of the lower head corresponding to a position of clamping groove, and the bump is slidable along the clamping groove.

13. The clamping plier head according to claim 12, wherein the clamping plier head further comprises a buckle which is arranged on a side proximate to the second end, and when the fourth end and the second end are clamped, the buckle is configured for buckling the second end.

14. The clamping plier head according to claim 3, wherein a first end of the upper head is hinged with a third end of the lower head, a second end of the upper head opposite to the first end is detachably clamped with a fourth end of the lower head opposite to the third end; the fourth end of the lower head is clamped with the second end of the upper head to form an accommodating cavity, and the fourth end and the second end are respectively provided with the clamping groove and a bump which are matched with each other.

15. The clamping plier head according to claim 14, wherein the second end is cylindrical in shape, the clamping groove is radially arranged on a cylindrical side of the second end, an axial section of the upper head is semi-circular, the bump is arranged on the side of the lower head corresponding to a position of clamping groove, and the bump is slidable along the clamping groove.

16. The clamping plier head according to claim 15, wherein the clamping plier head further comprises a buckle which is arranged on a side proximate to the second end, and when the fourth end and the second end are clamped, the buckle is configured for buckling the second end.
